(19) United States
(12) Patent Application Publication
(10) Pub. No.: US 2012/0196654 A1
(43) Pub. Date: Aug. 2, 2012

(54) RECEIVER AND TRANSMITTER

(75) Inventors: Shuzi Jin, Akishima-shi (JP); Kazuya Fukushima, Hamura-shi (JP)

(73) Assignee: KABUSHIKI KAISHA TOSHIBA, Tokyo (JP)

(21) Appl. No.: 13/328,984

(22) Filed: Dec. 16, 2011

(30) Foreign Application Priority Data
Jan. 31, 2011 (JP) 2011-019219

(51) Int. Cl. H04B 1/38

(52) U.S. Cl. 455/558

(57) ABSTRACT

According to one exemplary embodiment, a receiver is provided with: a first wireless communication module which performs first wireless communication; a second wireless communication module which performs second wireless communication; a storage module which stores authentication information which is received by the second wireless communication and used in the first wireless communication; and a controller which performs the first wireless communication with the first communication module using the authentication information stored in the storage module, and which deletes the authentication information from the storage module when the first wireless communication is ended.

### CROSS REFERENCE TO RELATED APPLICATION(S)

The application is based upon and claims the benefit of priority from Japanese Patent Application No. 2011-019219 filed on Jan. 31, 2011; the entire content of which are incorporated herein by reference.

### FIELD

Exemplary embodiments described herein relate generally to a receiver and a transmitter.

### BACKGROUND

Generally, a portable telephone using a subscriber identity module (SIM) card which stores SIM information is connected to a communication line of a contracted carrier, using authentication information stored in the SIM card.

A technique has been disclosed to exchange SIM information between communication terminals each of which can communicate with a carrier and to mutually be connected to communication lines to which the respective communication terminals belong.

### BRIEF DESCRIPTION OF THE DRAWINGS

Exemplary embodiments of the present invention will be described in detail based on the following figures, wherein:

FIG. 1 is a configuration diagram showing a communication system according to an embodiment;

FIG. 2 is a functional block diagram showing a personal computer according to the embodiment;

FIG. 3 is a functional block diagram showing a portable terminal according to the embodiment;

FIG. 4 is a sequence diagram showing communication control according to the embodiment;

FIG. 5 is a flowchart showing a communication control procedure performed by a personal computer according to the embodiment; and

FIG. 6 is a flowchart showing a communication control procedure performed by a portable terminal according to the embodiment.

### DETAILED DESCRIPTION OF THE EXEMPLARY EMBODIMENTS

In general, according to one exemplary embodiment, a receiver is provided with: a first wireless communication module which performs first wireless communication; a second wireless communication module which performs second wireless communication; a storage module which stores authentication information which is received by the second wireless communication and used in the first wireless communication; and a controller which performs the first wireless communication with the first communication module using the authentication information stored in the storage module, and which deletes the authentication information from the storage module when the first wireless communication is ended.

Hereinafter, an embodiment is described with reference to the drawings.

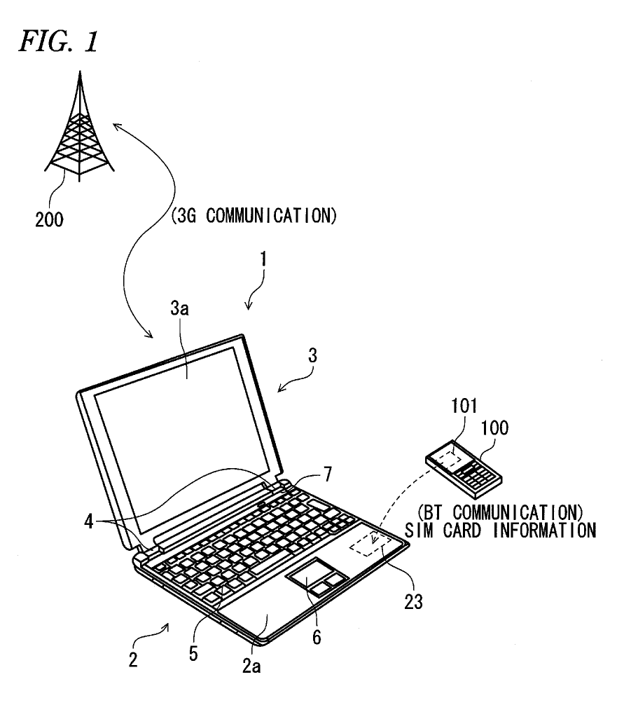

FIG. 1 is a configuration diagram showing a communication system according to the embodiment. The communication system is configured to include a receiver in which no SIM card is mounted, and a transmitter in which a SIM card is mounted. The communication system according to the present embodiment is configured to include a personal computer 1 serving as the receiver, and a portable terminal 100 serving as the transmitter provided with a SIM card 101. The SIM card 101 stores, e.g., authentication information (SIM card information) for performing third-generation (3G) communication, and performs 3G communication with a base station 200 of a telecommunication carrier, using the SIM card information.

As shown in FIG. 1, the personal computer 1 having no SIM card receives the SIM card information from the portable terminal 100 having the SIM card 101 via short-range wireless communication. An example of the short-range wireless communication is Bluetooth (registered trademark (hereinafter also referred to as BT)) communication. The BT communication uses a frequency band ranging from 2.4 gigahertz (GHz) to 2.5 GHz. The personal computer 1 causes a SIM card information storage module 24 to store received SIM card information, and performs 3G communication with the base station 200, using the stored SIM card information. The 3G communication method uses a frequency band ranging from, e.g., 1.92 GHz to 2.17 GHz.

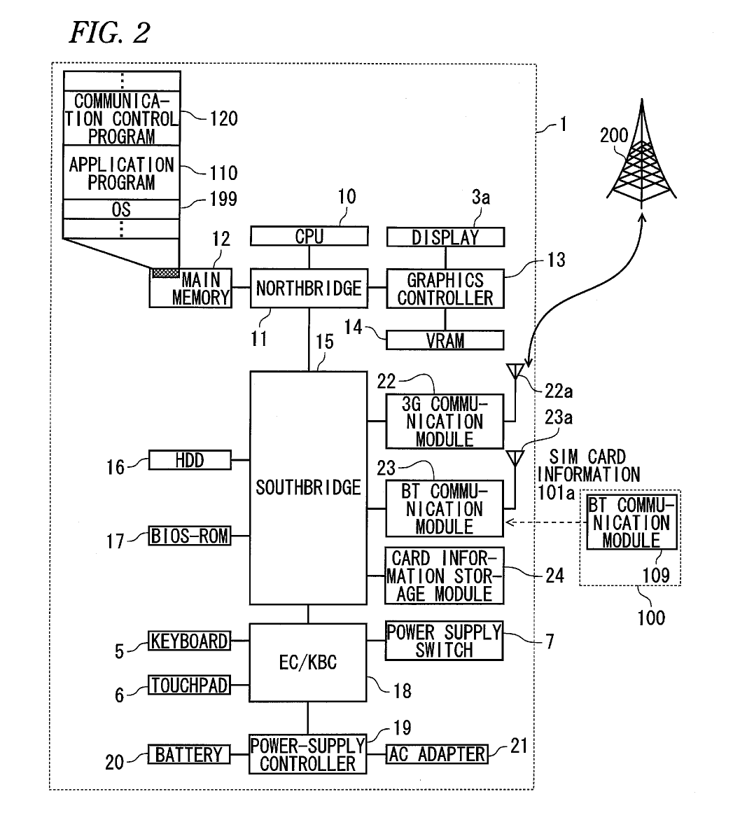

FIG. 2 is a functional block diagram showing a personal computer 1 according to the present embodiment. The personal computer 1 according to the present embodiment includes a display 3a, a keyboard 5, a touchpad 6, a power-supply switch 7, a central processing unit (CPU) 10, a northbridge 11, a main memory 12, a graphics controller 13, a video random access memory (VRAM) 14, a southbridge 15, a hard disk drive (HDD) 16, a basic input output system read-only memory (BIOS-ROM) 17, an embedded controller/keyboard controller (EC/KBC) 18, a power-supply controller 19, a battery 20, an alternate current (AC) adapter 21, a 3G communication module 22, a BT communication module 23, and a SIM card information storage module 24.

The display 3a displays images based on image signals sent from the graphics controller 13.

The keyboard 5 and the touchpad 6 are input devices for inputting various operation signals to the personal computer 1 in response to operations performed by users.

The power-supply switch 7 inputs, in response to users' operations, control signals for power-on/power-off of the personal computer 1.

The CPU 10 is a processor provided to control an operation of the personal computer 1, and executes an operating system and various application programs loaded from the HDD 16 into the main memory 12. The CPU 10 also executes a system BIOS after the system BIOS stored in the BIOS-ROM 17 is loaded into the main memory 12. The system BIOS is a program for hardware control.

The northbridge 11 is a bridge device for connecting between a local bus of the CPU 10 and the southbridge 15. The northbridge 11 incorporates a memory controller for controlling access to the main memory 12. The northbridge 11 also has a function of performing communication with the graphics controller 13 via an accelerated graphics port (AGP) bus or the like.

The main memory 12 is what is called a working memory for loading the operating system and the various application programs stored in the HDD 16 and the system BIOS stored in the BIOS-ROM 17.

In the present embodiment, an operating system (OS) 199, an application program 110, and a communication control program 120 are loaded in the main memory 12. The communication control program 120 is executed to thereby perform the following various control operations. That is, when a signal representing start of 3G communication issued by a user's operation is received, a command for requesting SIM card information 101a from a device having a SIM card 101 is sent thereto via BT communication. Then, the received SIM card information 101a is stored. In addition, 3G communication is performed using the stored SIM card information 101a. Upon completion of the 3G communication, the stored SIM card information 101a is deleted.

The graphics controller 13 is a display controller for controlling the display 3a used as a display monitor for the personal computer 1. The graphics controller 13 generates, from display data written to the VRAM 14 by the operating system/the application program, image signals representing a display image to be displayed in the display 3a.

The southbridge 15 accesses the BIOS-ROM 17 and controls disk drives (I/O devices) such as the HDD 16 and an optical disk drive (ODD). In addition, in the present embodiment, the 3G communication module 22, the BT communication module 23, and the SIM card information storage module 24 are connected to the southbridge 15.

The HDD 16 is a storage device that stores an operating system, and various application programs and the like.

The BIOS-ROM 17 is a nonvolatile and rewritable memory which stores a system BIOS that is a program for hardware control.

The EC/KBC 18 controls the keyboard 5 and the touchpad 6 that are provided as input devices. The EC/KBC 18 is a one-chip microcomputer that monitors and controls various devices (peripheral devices, sensors and power-supply circuits), regardless of the system status of the personal computer 1. The EC/KBC 18 also has a function of performing the power-on/power-off of the present personal computer 1 in response to a user's operation of the power-supply switch 7 in cooperation with the power-supply controller 19.

If external power is supplied via the AC adapter 21, the power-supply controller 19 generates system power to be supplied to each component of the personal computer 1 using the external power supplied from the AC adapter 21. If the external power is not supplied via the AC adapter 21, the power-supply controller 19 generates system power to be supplied to each component (e.g., a computer main unit 2, and a display unit 3) of the personal computer 1, using the battery 20.

The 3G communication module 22 transmits and receives electric waves of a predetermined frequency band to and from the carrier's base station 200 via a 3G antenna 22a. The 3G communication module 22 establishes communication with the base station 200 using the SIM card information stored in the SIM card information storage module 24.

The BT communication module 23 performs BT communication with BT devices via a BT antenna 23a. If 3G communication is desired, the BT communication module 23 transmits a device having SIM card information 101a of a SIM card information request notification via BT communication, and receives the SIM card information 101a.

The SIM card information storage module 24 stores the SIM card information 101a received by the BT communication module 23. The SIM card information storage module 24 may be provided in either additional hardware or the main memory 12. Upon completion of 3G communication, the SIM card information 101a stored in the SIM card information storage module 24 is deleted therefrom by executing the communication control program 120.

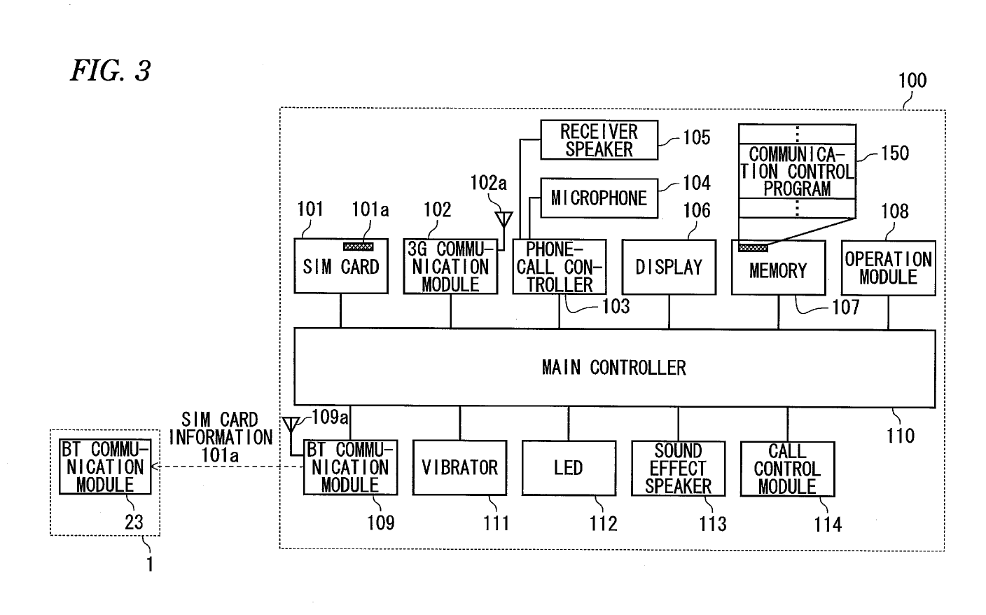

FIG. 3 is a functional block diagram showing the portable terminal 100 according to the present embodiment. The potable terminal 100 includes a SIM card 101, a 3G communication module 102, a phone-call controller 103, a microphone 104, a receiver speaker 105, a display 106, a memory 107, an operation module 108, a BT communication module 109, a main controller 110, a vibrator 111, a light emitting diode (LED) 112, a sound effect speaker 113, and a call control module 114.

The SIM card 101 is detachably provided in a SIM card slot provided in the portable terminal 100. The SIM card information 101a serving as authentication information required to perform 3G communication is stored in the SIM card 101.

The 3G communication module 102 transmits and receives electric waves of a predetermined frequency band with the base station 200 via a 3G antenna 102a. The 3G communication module 102 reads the SIM card information 101a from the SIM card 102 and establishes communication with the base station 200.

The phone-call controller 103 demodulates signals received using a call channel established by communication protocol control that is performed by the main controller 110. In addition, the phone-call controller 103 forms a call path to a counterpart apparatus by modulating signals to be transmitted.

The microphone 104 collects external sounds and converts the collected sounds into electrical (audio) signals. Then, the microphone 104 sends out the audio signals obtained by the conversion to the call path formed by the phone-call controller 103.

The receiver speaker 105 emits, to the outside, sounds corresponding to the audio signals from the call path formed by the phone-call controller 103.

The display 106 displays various types of information under the control of the main controller 110. When an incoming-call arrives, or when it reaches an alarm set time, the display 106 indicates such a fact.

The memory 107 stores application programs executed by the main controller 110, and various types of data such as phone book data and e-mail data. According to the present embodiment, the memory 107 stores communication control programs 150.

The operation module 108 includes numeric keys for inputting telephone numbers and the like, and function keys for executing various functions, and the like.

The BT communication module 109 performs BT communication with a BT device via the BT antenna 109a. According to the present embodiment, the BT communication module 109 performs BT communication with the BT communication module 23 of the personal computer 1. Then, the BT communication module 109 transmits the SIM card information 101a.

The main controller 110 controls the entire portable terminal 100 by controlling the other modules or components of the portable terminal 100. The main controller 110 performs communication protocol control performed in the 3G communication module 102, and controls a user interface and the like. In addition, when receiving from the 3G communication module 102 a signal indicating the arrival of an incoming-call, the main controller 110 informs the incoming-call arrival with informing devices such as the vibrator 111, the LED 112, the sound effect speaker 113, and the display 106. Besides, when an event to be informed occurs, the main controller 110 informs the occurrence of the event using the above informing devices by executing application-programs relating to an alarm function and a scheduling function.

In addition, the main controller 110 controls the following operations by executing the communication control programs 150. That is, when receiving, from a device (e.g., the personal computer 1) not having the SIM card 101, a notification requesting the SIM card information 101a via BT communication, the portable terminal 100 transmits the SIM card information 101a. Upon completion of transmitting the SIM card information 101a, the portable terminal 100 locks the SIM card 101. When receiving from a transmission receiving device a 3G communication termination notification, the portable terminal 100 unlocks the SIM card 101.

The vibrator 111 is accommodated in the casing of the portable terminal 100 and vibrates in response to the occurrence of the informed event. Generally, the vibrations of the vibrator 111 are caused by attaching a weight, whose center of gravity is biased, to the shaft of a motor and then rotating the motor.

The LED 112 is provided to be exposed from a surface of the casing of the portable terminal 100 and emits light in response to the occurrence of the informed event.

The sound effect speaker 113 is accommodated in the casing of the portable terminal 100 and outputs sounds in response to the occurrence of the informed event.

The call control module 114 controls operations of the informing devices, such as the vibrator 111, the LED 112, the sound effect speaker 113, and the display portion 106, according to the event to be informed.

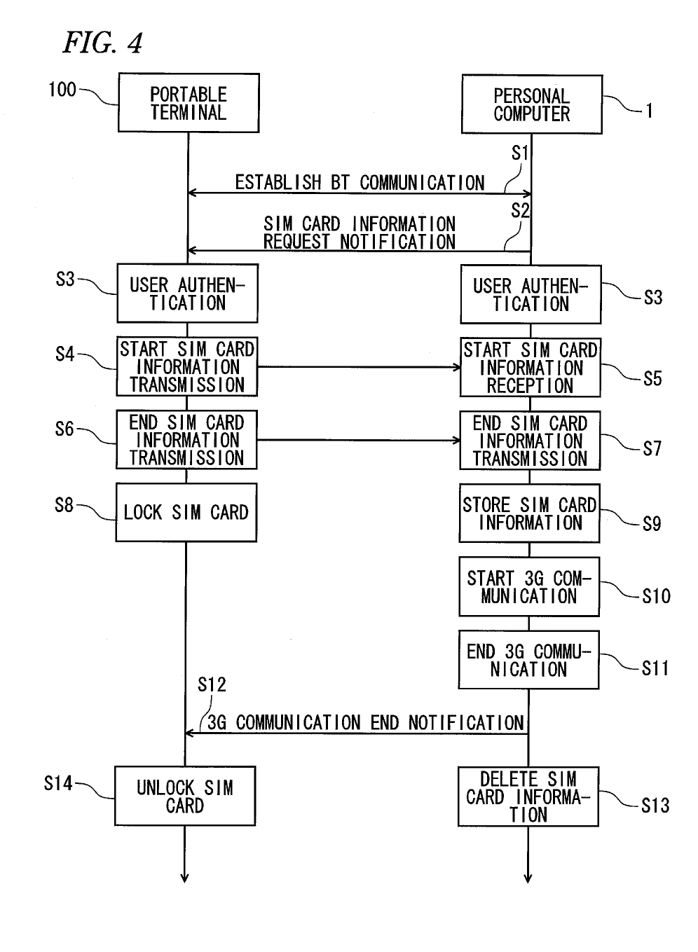

FIG. 4 is a sequence diagram showing communication control according to the present embodiment. Referring to FIG. 4, the case of transmitting the SIM card information 101a to the personal computer 1 from the portable terminal 100 provided with the SIM card 101 and perform 3G communication with the personal computer 1 is described as an example.

First, in step S1, BT communication is established between the portable terminal 100 and the personal computer 1. For example, one of such devices makes an inquiry about whether any counterpart device at the other end of connection is present therearound. Then, the inquiring device selects one of devices that respond to the inquiry to thereby establish BT communication with the selected device. Alternatively, a set of devices which users own can preliminarily be registered as devices to be subjected to BT communication. If BT communication is established between the devices, step S1 is omitted. Next, in step S2, the personal computer 1 transmits a SIM card information requesting notification to the portable terminal 100 via BT communication.

Then, in step S3, each of the portable terminal 100 and the personal computer 1 performs user authentication. The SIM card information 101a includes authentication information needed when 3G communication is performed. Thus, when performing the transmission and reception of the SIM card information 101a therebetween, both the devices perform user authentication including the input of a personal identification number (PIN) code. If the devices to be subjected to BT communication are preliminarily registered, user authentication can be omitted.

If the authentication is successful, in step S4, the portable terminal 100 starts the transmission of the SIM card information 101a to the personal computer 1. Thus, in step S5, the personal computer 1 starts the reception of the SIM card information 101a.

In step S6, if the portable terminal 100 ends the transmission of the SIM card information 101a, in step S7, the personal computer 1 ends the reception of the SIM card information 101a.

Next, in step S8, the portable terminal 100 locks the SIM card 101. That is, after the transmission of the SIM card information 101a, the portable terminal 100 cannot perform 3G communication. Thus, the present embodiment prevents the occurrence of a state in which there are a plurality of devices capable of performing 3G communication using the SIM card 101. In step S9, the personal computer 1 causes the SIM card information storage module 24 to store the SIM card information 101a.

Next, in step S10, the personal computer 1 starts 3G communication using the SIM card information 101a stored in the SIM card information storage module 24. If the 3G communication is ended in step S11, in step S12, the personal computer 1 transmits, via BT communication, a notification indicating the end of the 3G communication to the portable terminal 100.

Next, in step S13, the personal computer 1 deletes the stored SIM card information 101a from the SIM card information storage module 24. That is, a state in which the SIM card information 101a is copied is not continued. Upon completion of 3G communication, the SIM card information 101a is deleted. Accordingly, the unauthorized use of the SIM card information 101a can be prevented. In response to the deletion of the SIM card information 101a in step S13, in step S14, the portable terminal 100 unlocks the SIM card 101.

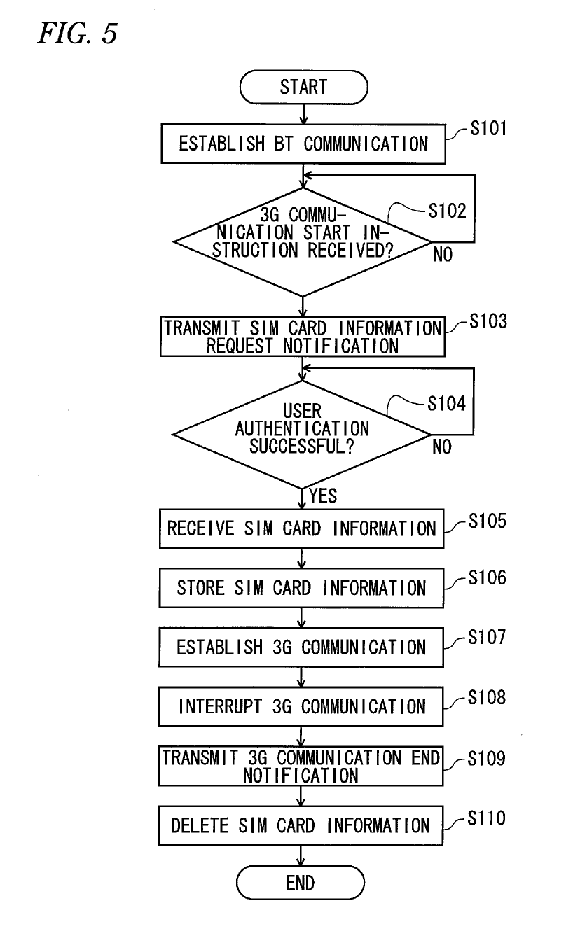

FIG. 5 is a flowchart showing a communication control procedure performed by the personal computer 1 according to the present embodiment.

First, in step 5101, the BT communication module 23 establishes BT communication with the portable terminal 100 which is a counterpart device at the other end of communication. If BT communication is already established therebetween, step S101 is omitted. Next, in step S102, the CPU 10 determines whether the CPU 10 receives from the input device provided in the personal computer 1 a signal instructing the start of 3G communication. If the CPU 10 accordingly determines that the CPU 10 does not receive the signal instructing the start of 3G communication (No in step S102), the CPU 10 returns to the beginning of step S102. On the other hand, if the CPU 10 accordingly determines that the CPU 10 receives the signal instructing the start of 3G communication (Yes in step S102), in step S103, the BT communication module 23 transmits a SIM card information requesting notification to the portable terminal 100.

Next, in step S104, the CPU 10 determines, using a user authentication input signal received from the keyboard 5 or the touchpad 6, whether user authentication is successful. If the CPU 10 accordingly determines that the user authentication is not successful (No in step S104), the CPU 10 returns to the beginning of step S104. That is, if the user authentication is not successful, the BT communication module 23 does not perform the transmission and reception of the SIM card information 101a.

On the other hand, if the CPU 10 accordingly determines that the user authentication is successful (Yes in step S104), in step S105, the BT communication module 23 starts receiving the SIM card information 101a through BT communication. Next, in step S106, upon completion of reception of the SIM card information 101a, the BT communication module 23 causes the SIM card information storage module 24 to store the SIM card information 101a.

Next, in step S107, the 3G communication module 22 establishes 3G communication with the base station 200, using the SIM card information 101a stored in the SIM card information storage module 24. Then, in step S108, when data communication and a voice call are ended, the 3G communication module 23 disconnects the 3G communication. Next, in step S109, the BT communication module 23 transmits a notification indicating the end of the 3G communication to the portable terminal 100. Next, in step S110, the CPU 10 deletes the SIM card information 101a stored in the SIM card information storage module 24. Thus, the communication control procedure performed by the personal computer 1 is ended.

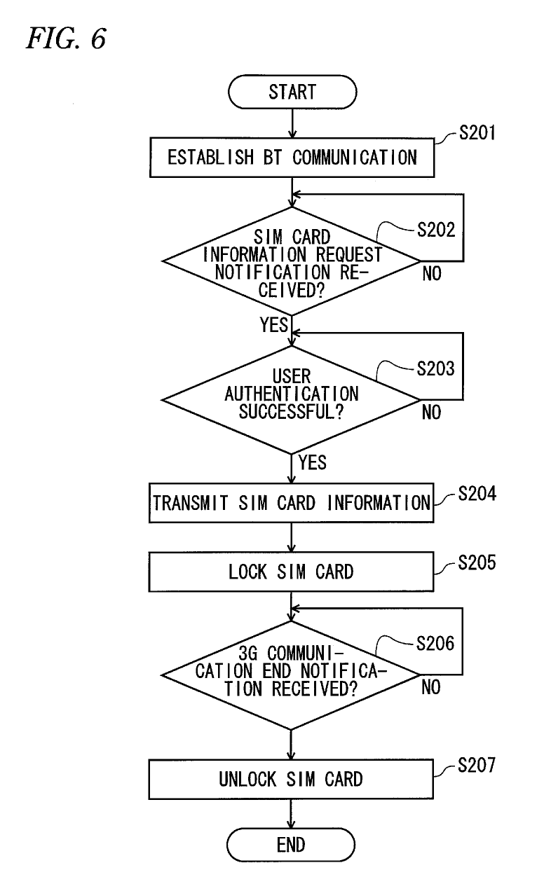

FIG. 6 is a flowchart showing a communication control procedure performed by the portable terminal 100 according to the present embodiment.

In step S201, the BT communication module 109 establishes BT communication with the personal computer 1 which is a counterpart device at the other end of communication. If BT communication is already established, step S201 is omitted. Next, in step S202, the BT communication module 109 determines whether the BT communication module 109 receives a notification requesting the SIM card information 101a. If the BT communication module 109 accordingly determines that the BT communication module 109 does not receive the notification requesting the SIM card information 101a (No in step S202), the BT communication module 109 returns to the beginning of step S202. On the other hand, if the BT communication module 109 accordingly determines that the BT communication module 109 receives the notification requesting the SIM card information 101a (Yes in step S202), in step S203, the main controller 110 determined, using a user authentication input signal received from the operation module 108, whether user authentication is successful.

If the main controller 110 accordingly determines that the user authentication is not successful (No in step S203), the main controller 110 returns to the beginning of step S203. That is, if the user authentication is not successful, the BT communication module 109 does not transmit the SIM card information 101a.

On the other hand, if the main controller 110 accordingly determines that the user authentication is successful (Yes in step S203), in step S204, the BT communication module 109 reads the SIM card information 101a from the SIM card 101, and starts transmitting the SIM card information 101a by BT communication. Next, in step S205, the main controller 110 locks the SIM card 101 (i.e., suspends the function thereof).

Then, in step S206, the BT communication module 109 determines whether the BT communication module 109 receives, from the personal computer 1 which is the counterpart device, a notification indicating the end of the 3G communication. If the BT communication module 109 accordingly determines that the BT communication module 109 does not receive the notification indicating the end of the 3G communication (No in step S206), the BT communication module 109 returns to the beginning of step S206. The SIM card 101 is locked in a device which transmits the SIM card information 101a, i.e., the device which copies the SIM card information 101a, until the end of the 3G communication.

On the other hand, if the BT communication module 109 accordingly determines that the BT communication module 109 receives the notification indicating the end of the 3G communication (Yes in step S206), in step S207, the main controller 110 unlocks the SIM card 101. Thus, the communication control procedure performed by the portable terminal 100 is ended.

As described above, according to the present embodiment, 3G communication can be implemented without mounting the SIM card 101 in the personal computer 1. That is, the personal computer 1 utilizes the SIM card information 101a received from the portable terminal 100 via the BT communication thereby to be able to perform 3G communication, without the SIM card 101. In addition, when the 3G communication is ended, the SIM card information 101a is deleted from the personal computer 1 Consequently, the unauthorized use of the SIM card can be prevented.

While certain exemplary embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A receiver comprising:
a first wireless communication module configured to perform first wireless communication;
a second wireless communication module configured to perform second wireless communication;
a storage module configured to store authentication information which is received by the second wireless communication and used in the first wireless communication; and
a controller configured to perform the first wireless communication with the first communication module using the authentication information stored in the storage module and to delete the authentication information from the storage module when the first wireless communication has ended.

2. The receiver of claim 1, wherein the controller is configured to establish the second wireless communication when receiving a signal requesting to start the first wireless communication.

3. The receiver of claim 2, wherein the controller is configured to establish the second wireless communication by selecting a counterpart communication device from a plurality of communication devices located around the receiver.

4. The receiver of claim 2, wherein the controller is configured to establish the second wireless communication with a preliminarily registered counterpart communication device.

5. A transmitter comprising:
a first wireless communication module configured to perform first wireless communication;
a second wireless communication module configured to perform second wireless communication with a counterpart communication device; and
a controller configured to transmit, to the counterpart communication device, authentication information used in the first wireless communication via the second wireless communication and to disable the first wireless communication after transmitting the authentication information.

6. The transmitter of claim 5, wherein the controller is configured to enable the first wireless communication when receiving, from the counterpart communication device via the second wireless communication, a notification indicating that the first wireless communication using the authentication information has ended.
